(19) United States
(12) Patent Application Publication
(10) Pub. No.: US 2005/0220327 A1
(43) Pub. Date: Oct. 6, 2005

(54) Image collation device, image collation method, image collation program, and computer-readable recording medium with image collation program recorded thereon

(76) Inventors: Yasufumi Itoh, Tenri-shi (JP); Manabu Yumoto, Nara-shi (JP); Manabu Onozaki, Nara-shi (JP); Mitsuaki Nakamura, Chiba-shi (JP)

Correspondence Address: BIRCH STEWART KOLASCH & BIRCH, PO BOX 747, FALLS CHURCH, VA, 22040-0747, US

(21) Appl. No.: 11/091,502

(22) Filed: Mar. 29, 2005

(30) Foreign Application Priority Data
Mar. 30, 2004 (JP) 2004-098817

(51) Int. Cl. G06K 9/00

(52) U.S. Cl. 382/124

(57) ABSTRACT

An image collation device capable of obtaining a high collating precision with a reduced amount of searches is constituted as follows. The image collation device includes an input unit which receives data representing an image A and data representing an image B, and a processing unit which determines whether or not a possibility that a center region of the image A which is a portion thereof matches with any portion of the image B is below a threshold value T(2) and determines whether or not the image A matches with the image B when it is determined the possibility that the center region matches with the any portion of the image B is equal to or more than the threshold value T(2).

This nonprovisional application is based on Japanese Patent Application No. 2004-098817 filed with the Japan Patent Office on Mar. 30, 2004, the entire contents of which are hereby incorporated by reference.

### BACKGROUND OF THE INVENTION

1. Field of the Invention

The present invention relates to an image collation device, an image collation method, an image collation program, and a computer-readable recording medium with the image collation program recorded thereon. More particularly, the present invention relates to an image collation device, an image collation method and an image collation program for collating a plurality of images, and a computer-readable recording medium with the image collation program recorded thereon.

2. Description of the Background Art

Japanese Patent Laying-Open No. 2003-323618 discloses a conventional fingerprint collation method. Herein, of two images, a portion of one of the images and a portion of the other image which is the most similar to the portion of one of the images are defined in their positional correlativity so that the fingerprint collation is carried out. More specifically, the method disclosed in Japanese Patent Laying-Open No. 2003-323618 includes the following steps. In a first step, a sensing image (image detected by a sensor) is divided into partial regions. A second step is in charge of searching which position of a template image (previously prepared image used for comparison) has a partial image to which an image of each partial region is the most similar (the search is carried out to all of the partial regions of the sensing image). In a third step, a positional relationship between the partial images searched in the second step is clarified when the sensing image and the template image are overlapped with each other. In the following description, the clarification of the positional relationship is referred to as “maximum-match position search”. Further, in the following description, a vector connecting respective centers of the partial regions of the sensing image and the partial regions of the template image when they are overlapped with each other is referred to as “moving vector”. In a fourth step, if the fingerprints are identical is determined based on a distribution of the moving vector between the sensing image and the template image which are the most match.

However, as disclosed in Japanese Patent Laying-Open No. 2003-323618, the fingerprint collation through the first to fourth steps unfavorably requires a large amount of processing time and power consumption. Such a problem is caused because there is a large volume of information to be processed. A large volume of information is to processed because the whole of one of the images is divided into a plurality of partial regions and the maximum-match position search is carried out to all of the partial regions.

Referring to FIG. 8, the problems included in the method disclosed in Japanese Patent Laying-Open No. 2003-323618 will be more specifically described. FIG. 8(A)-1, FIG. 8(A)-2 and FIG. 8(A)-64 in FIG. 8 respectively show the same sensing image (image A). Any image other than the sensing image represents the same template image (image B). Image A is divided into 64 partial regions (a size of one partial region is 16×16 pixels). The respective partial regions are provided with discrimination numbers R(1) to R(64). FIG. 8(A)-i shows partial region R(1) of image A in an emphasized state. FIG. 8(B)1-1 to FIG. 8(B)1-12769 respectively show statuses in which the process of the second step is being carried out to partial region R(1). As the process of the second step advances, a position of a region on image (B), which is compared with an image of partial region R(1) of image A, shifts by one pixel. The region of 16×16 pixels on image (B) is compared with partial region R(1). A width of the shift of the position on image (B) corresponds to one pixel in a horizontal or vertical direction. As shown in FIG. 8(B)1-12769, the image of partial region R(1) of image A is finally compared with a lower-right partial region on image (B) (upper-left coordinates of the region are (113, 113)). FIG. 8(A)-2 and FIGS. 8(B)2-1 to 8(B)2-12769 respectively show statuses in which the process of the second step is being carried to partial region R(2) of image A. FIG. 8(A)-64 to FIG. 8(B)64-12769 respectively show statuses in which the process of the second step is being carried to partial region R(64) of image A.

The number of the partial regions searched in the present case is calculated as follows:
(Number of regions)=(Number of searches for partial regions on image B relative to partial region of image A)×(Number of partial regions of image A)

In the present example, the number of searches for the partial regions on image B relative to a partial region of image A is 113×113=12769. Because the number of the partial regions on image A is 64, the number of the partial regions to be searched is calculated as follows:
Number of regions (conventional technology)=12769×64=817216

As seen in the foregoing example, the number of the partial regions necessarily to be searched for the fingerprint collation, that is, an amount of searches is significantly large. The large number of the searches is a barrier to the dissemination of an individual authentication technology (mainly a technology to which the biometrics technology such as the fingerprint collation is applied) to commercial apparatuses (in particular, mobile telephone, PDA (Personal Digital Assistant and information mobile terminal) and the like used by an individual) because a volume of power consumed for the collation process alone possibly goes beyond a capacity of a battery installed in the commercial apparatus unless time required for the individual authentication is reduced to a possible minimum level. As another disadvantage, the large amount of searches can undermine a competitive advantage among companies.

### SUMMARY OF THE INVENTION

The present invention has been implemented in order to solve the foregoing problems, and a main object thereof is to provide an image collation device, an image collation method, and an image collation program capable of obtaining a high collating precision with a reduced amount of searches, and a computer-readable recording medium with the image collation program recorded thereon.

In order to achieve the foregoing object, an image collation device according to an aspect of the present invention includes a reception device for receiving data representing a first image and data representing a second image, a first determination circuit for determining whether or not a possibility that a first portion which is a portion of the first image matches with any portion of the second image is below a predetermined first value, and a second determination circuit for determining whether or not the first image matches with the second image when the first determination circuit determines the possibility that the first portion matches with the any portion of the second image is equal to or more than the first value.

More specifically, when the first determination circuit determines the possibility that the first portion matches with the any portion of the second image is below the first value, the possibility that the first image and the second image matches with each other is lowered. The second determination circuit determines whether or not the first image matches with the second image when the possibility that the first portion matches with the any portion of the second image is equal to or more than the first value. According to the foregoing constitution, whether or not the first image matches with the second image can be determined with a reduced volume of searches while a high collating precision is being maintained. As a result, the image collation device capable of obtaining the high collating precision with the reduced amount of searches can be provided.

Desirably, the foregoing image collation device further includes a third determination circuit for determining whether or not the possibility that the first portion matches with the any portion of the second image is equal to or more than a second value exceeding the first value. Desirably, the second determination circuit includes a circuit for determining whether or not the first image matches with the second image when the possibility that the first portion matches with the any portion of the second image is equal to or more than the first value and less than the second value.

More specifically, when the possibility that the first portion matches with the any portion of the second image is equal to or more than the second value, the first image and the second image may match with each other at a higher rate. The second determination circuit determines whether or not the first image matches with the second image when the possibility that the first portion matches with the any portion of the second image is equal to or more than the first value and less than the second value. According to the foregoing constitution, whether or not the first image matches with the second image can be determined with a reduced amount of searches while a higher collating precision is being maintained. As a result, the image collation device capable of obtaining the higher collating precision with the reduced amount of searches can be provided.

Desirably, the first determination circuit includes a specified circuit for similarity for specifying a similarity of the any portion of the second image relative to a partial region which is a portion of the first portion, a specified circuit for correlation for specifying a correlativity between a layout of a plurality of partial regions and a layout of the any portion of the second image having a highest similarity, and a circuit for determining whether or not the correlativity is below the first value.

Desirably, the second determination circuit includes a specified circuit for similarity for specifying a similarity of the any portion of the second image relative to the partial region which is a portion of the first image, a specified circuit for correlation for specifying the correlativity between the layout of the partial regions and the layout of the portion having the highest similarity, and a circuit for determining whether or not the correlativity is below a predetermined value.

Desirably, the first image and the second image include an image representing a fingerprint. Desirably, the partial region preferably includes a region in which a length of a line crossing the partial region and orthogonal to a ridge of the fingerprint is equal to or more than twice and equal to or less than three times as long as a sum of a width of the ridge and a width of a groove.

Desirably, the first image and the second image include an image representing a pattern inherent in a human body.

More specifically, the first image and the second image respectively represent the pattern inherent in the human body. Thereby, the collation based on a position and a characteristic of the pattern can be realized. As a result, the image collation device capable of performing collation in accordance with the position and characteristic of the pattern and obtaining the high collating precision with a reduced amount of searches can be provided.

Desirably, the pattern inherent in the human body includes a pattern formed by a configuration of a vasa sanguinea retinae or a vasa sanguinea chorioidea.

More specifically, the pattern formed by the configuration of the vasa sanguinea retinae or vasa sanguinea chorioidea changes over time. Based on the change, a difference between a time point when the first image was photographed and a time point when the second image was photographed can be estimated to a certain extent, which enables the different human bodies to be discriminated. As a result, the image collation device capable of reducing the amount of searches, estimating the difference between the time points of the photographing to a certain extent and obtaining the high collating precision can be provided.

Desirably, the first image and the second image include an image representing the configuration of the vasa sanguinea retinae or vasa sanguinea chorioidea. Desirably, the first portion is a portion including an optic nerve papilla.

More specifically, the pattern formed by the configuration of the vasa sanguinea retinae or vasa sanguinea chorioidea changes over time. Further, when the first image and the second image are respectively the image representing the configuration of the vasa sanguinea retinae or vasa sanguinea chorioidea in the portion including the optic nerve papilla, the difference between the time points when the first image and the second image were respectively photographed can be estimated to a certain extent while a possibility of false recognition caused by the passage of time is being controlled. As a result, the image collation device capable of reducing the amount of searches, estimating the difference between the time points of the photographing to a certain extent and obtaining the high collating precision can be provided.

Desirably, the first image and the second image include an image representing the fingerprint. Desirably, the first portion includes a portion closer to a top joint of a finger than a tip of the finger.

More specifically, the first determination circuit determines whether or not a possibility that a portion of the first image closer to the top joint of the finger than the tip of the finger matches with the any portion of the second image is below the first value. The fingerprint in the portion closer to the top joint than the tip of the finger is largely different from one individual to another. The precision in the determination made by the first determination circuit can be thereby increased. As a result, the image collation device capable of reducing the amount of searches and obtaining the high collating precision can be provided.

Desirably, the portion closer to the top joint of the finger than the tip of the finger includes a center of an arc drawn by the fingerprint.

More specifically, the first determination circuit determines whether or not a possibility that a portion of the first image including the center of the arc drawn by the fingerprint matches with the any portion of the second image is below the first value. The fingerprint in the portion including the center of the arc drawn by the fingerprint is remarkably different from one individual to another. Thereby, the precision of the determination made by the first determination circuit remarkably increases. As a result, the image collation device capable of reducing the amount of searches and obtaining the high collating precision can be provided.

Desirably, the first image and the second image include an image representing the fingerprint. Desirably, an area of the first portion is an area corresponding to 25 to 40% of a projected area of the finger.

More specifically, the first determination circuit determines whether or the possibility that the first portion matches with the any portion of the second image is below the first value when the area of the first portion is the area corresponding to 25 to 40% of the projected area of the finger. Thereby, the precision of the determination made by the first determination circuit further increases. As a result, the image collation device capable of reducing the amount of searches and obtaining the high collating precision can be provided.

Desirably, the first image and the second image include an image representing an imprint.

More specifically, the first determination circuit determines whether or not a possibility that the first portion representing the imprint matches with the any portion of the second image is below the first value. When the imprint is used, it is made easier to determine that the images are not match. Thereby, the precision of the determination made by the first determination circuit can be increased with the reduced amount of searches. As a result, the image collation device capable of obtaining the high collating precision with the reduced amount of searches can be provided.

An image collation method according to another aspect of the invention includes a reception step of receiving the data representing the first image and the data representing the second image, a first determination step of determining whether or not the possibility that the first portion which is a portion of the first image matches with the any portion of the second image is below the predetermined first value, and a second determination step of determining whether or not the first image matches with the second image when it is determined the possibility that the first portion matches with the any portion of the second image is equal to or more than the first value in the first determination step.

Thus, the image collation method capable of obtaining the high collating precision with the reduced amount of searches can be provided.

An image collation program according to still another aspect of the invention makes a computer execute a reception step of receiving the data representing the first image and the data representing the second image, a first determination step of determining whether or not the possibility that the first portion which is a portion of the first image matches with the any portion of the second image is below the predetermined first value, and a second determination step of determining whether or not the first image matches with the second image when it is determined the possibility that the first portion matches with the any portion of the second image is equal to or more than the first value in the first determination step.

Thus, the image collation program capable of obtaining the high collating precision with the reduced amount of searches can be provided.

A recording medium according to yet another aspect of the invention is a computer-readable recording medium with the image collation program recorded thereon. More specifically, the recording medium makes the computer execute the reception step of receiving the data representing the first image and the data representing the second image, the first determination step of determining whether or not the possibility that the first portion which is a portion of the first image matches with the any portion of the second image is below the predetermined first value, and the second determination step of determining whether or not the first image matches with the second image when it is determined the possibility that the first portion matches with the any portion of the second image is equal to or more than the first value in the first determination step.

Thus, the computer-readable recording medium with the image collation program capable of obtaining the high collating precision with the reduced amount of searches recorded thereon can be provided

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a functional constitution of an image collation device according to an embodiment of the present invention;

FIG. 2 shows a layout of partial regions in an image according to the embodiment;

FIG. 3 is a block diagram illustrating a constitution of computer hardware for realizing the image collation device according to the embodiment;

FIG. 4 is a flowchart of steps of a fingerprint collation process according the embodiment;

FIG. 5 is a flowchart of steps of a template matching, a similarity calculation process and a collation determination process according to the embodiment;

FIG. 6 is a flowchart of the steps of the similarity calculation process according to the embodiment;

FIG. 7 is a flowchart of step of a match calculation process according to the embodiment; and

FIG. 8 is a fingerprint collation process according to a conventional technology.

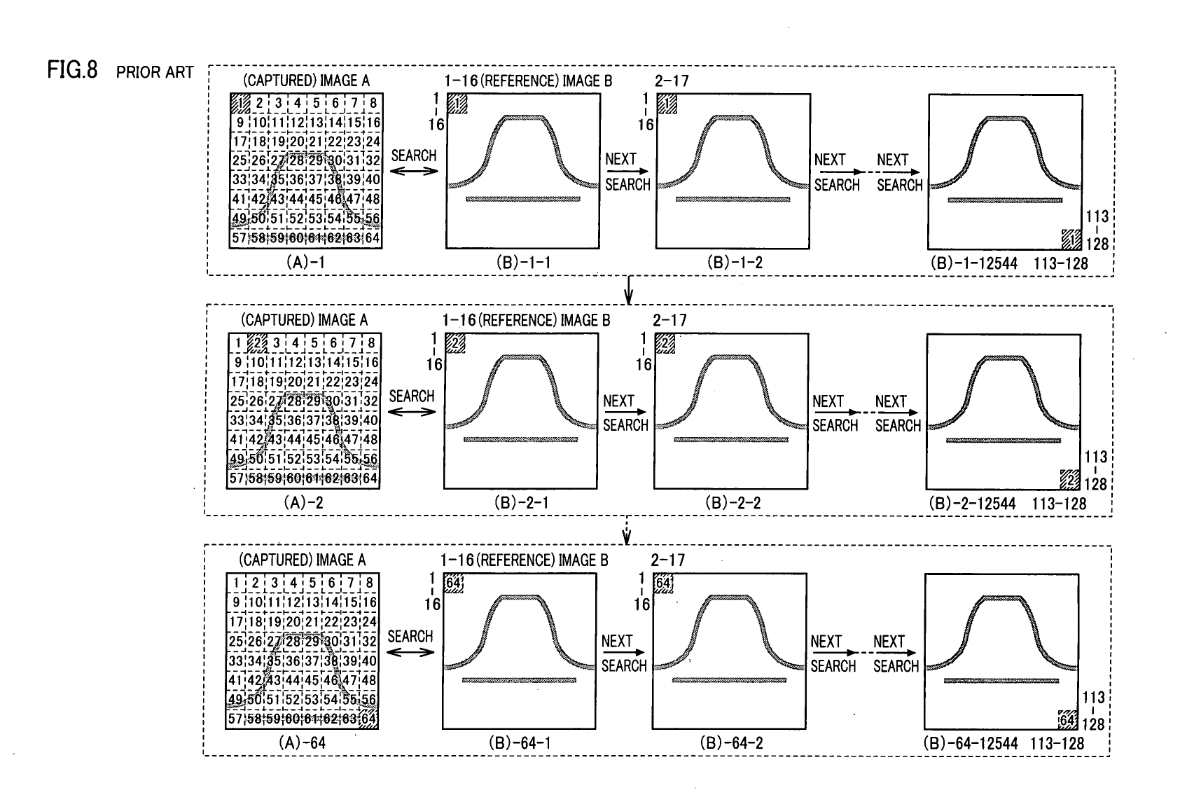

### DESCRIPTION OF THE PREFERRED EMBODIMENTS

Hereinafter, an embodiment of the present invention will be described referring to the drawings. In the description below, the same components are indicated by the same reference symbols, and they are called likewise and exert the same functions. Therefore, those same components are not repeatedly described in detail.

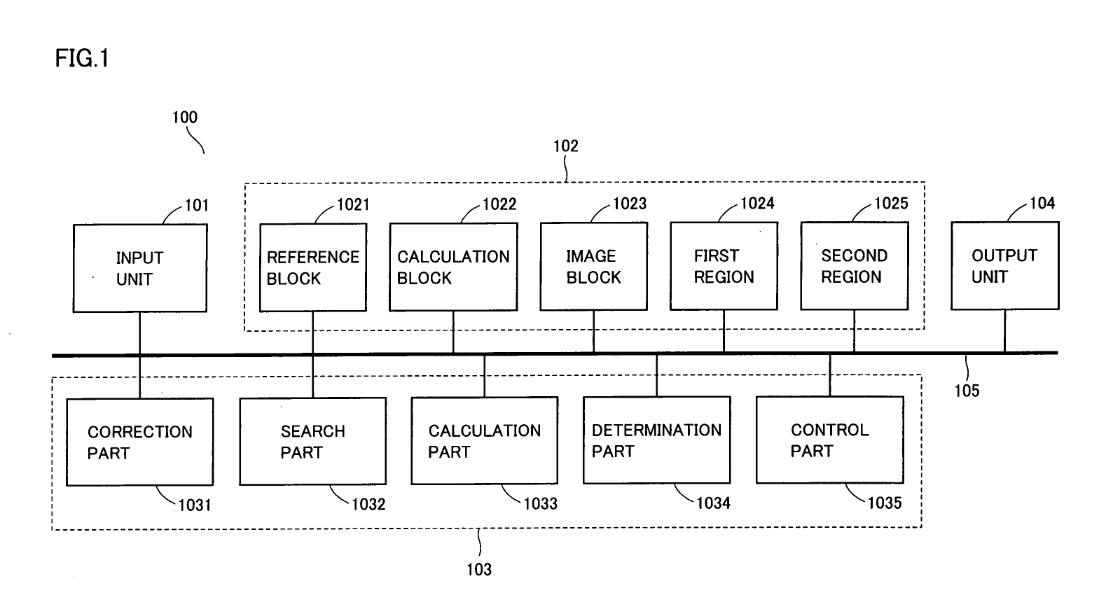

Referring to FIG. 1, an image collation device 100 according to the embodiment includes an input unit 101, a memory unit 102 (corresponding to a memory 624 and fixed disk 626, which will be described later), a processing unit 103, an output unit 104 (corresponding to a display 610 and a printer 690, which will be described later) and a bus 105. Input unit 101 includes a fingerprint sensor. Input unit 101 receives data representing an image A or data representing an image B through the fingerprint sensor. Images A and B are respectively an image of a fingerprint. Input unit 101 is a device for outputting image data of the read fingerprint image to memory unit 102 and processing unit 103. The fingerprint sensor is of an optical type, pressure type or electrostatic capacitance type, which is designated by a user. In the case of the present embodiment, the optical-type fingerprint sensor is included. Memory unit 102 stores therein image data and different calculation results. Processing unit 103 controls input unit 101 and memory unit 102. Processing unit 103 further serves as a circuit for executing a processing (including operation) of information required for the fingerprint collation. Output unit 104 outputs the information stored in memory unit 102 and the information generated by processing unit 103. Bus 105 transfers a control signal and a data signal between input unit 101, memory unit 102 and processing unit 103.

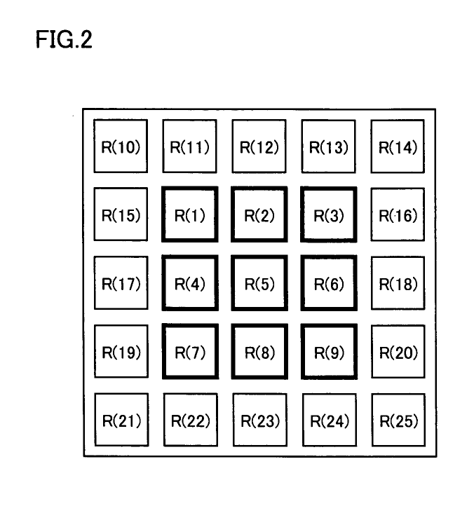

Memory unit 102 includes a reference block 1021, a calculation block 1022, an image block 1023, a first region 1024 and a second region 1025. Reference block 1021 is a block for temporarily storing data to be used for referencing. Calculation block 1022 is a block for temporarily storing data in executing the operation. Image block 1023 is a block for storing the image data of the sensing image and template image. First region 1024 and second region 1025 are respectively a region for storing positional information (“positional information” in the present embodiment refers to coordinates on the upper left of a partial region) and a moving vector. Referring to FIG. 2, a layout of the partial regions whose positional information is stored by first region 1024 and second region 1025. In the present embodiment, an entire region of the sensing image (image A) is divided into 25 partial regions, with which an entire image of the fingerprint is covered. The respective partial regions are provided with discrimination numbers such as R(1) to R(25). FIG. 2 shows the layout of the partial regions on image A. First region 1024 stores the positional information of the partial regions in a center portion consisting of partial regions R(1) to R(9). Second region 1025 stores the positional information of the partial regions in a peripheral portion consisting of partial regions R(10) to R(25).

Processing unit 103 includes a correction part 1031, a search part 1032, a calculation part 1033, a determination part 1034 and a control part 1035. Correction part 1031 corrects a density difference in the image data of image A inputted from input unit 101. Search part 1032 searches a position in the mage B at which a highest match level relative to a plurality of partial regions of the sensing image (image A) can obtained. Calculation part 1033 calculates a similarity based on a moving vector, which will be described later, by means of information resulting from the search of search part 1032 stored in memory unit 102. Determination part 1034 determines if a result of the fingerprint collation falls under “match”, “no match” or “undetermined” based on the similarity calculated by calculation part 1033. Control part 1035 controls the processes executed by the respective parts of processing unit 103.

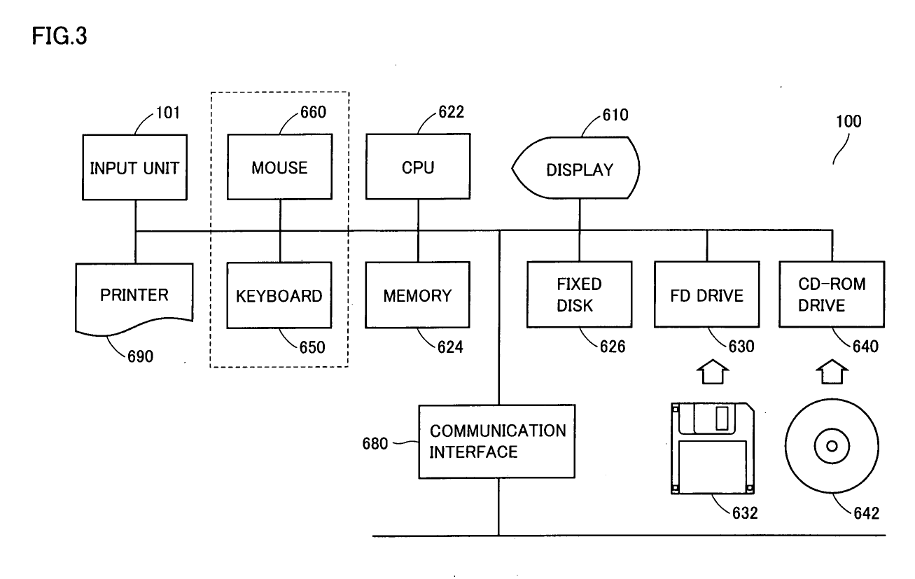

Image collation device 100 is realized by means of computer hardware shown in FIG. 3 and software executed by a CPU (Central Processing Unit) 622 shown in FIG. 3. Referring to FIG. 3, the computer hardware includes an input unit 101, a display 610 formed from liquid crystals (display 610 may be a CRT (Cathode-Ray Tube, however, display 610 according to the present embodiment is formed from the liquid crystals), a CPU 622 for intensively supervising and controlling the computer hardware, a memory 624 comprised of ROM (Read Only Memory) or RAM (Random Access Memory), a fixed disk 626, an FD drive 630 having an FD (Flexible Disk) 632 detachably mounted therein for accessing mounted FD 632, a CD-ROM drive 640 having a CD-ROM 642 detachably mounted therein for accessing mounted CD-ROM (Compact Disk Read Only Memory) 642, a communication interface 680 for connecting a communication network and the computer hardware and enabling communication therebetween, a keyboard 650 for receiving an input by keys, and a mouse 660 for receiving an input by so-called click & drag. The respective components mentioned above are communicated/connected via s bus. A magnetic tape device having a magnetic tape of a cassette type detachably mounted therein for accessing the magnetic tape may be provided in the computer hardware, however, such a device is not provided in the present embodiment. In general, the foregoing software is stored in the recording medium such as FD 632 and CD-ROM 642 and distributed, then, read from the recording medium by FD drive 630 and CD-ROM drive 640 and temporarily stored in fixed disk 626, and further, read therefrom by memory 624 to be executed by CPU 622. The computer hardware mentioned above is generally available. Therefore, the most essential part of the present invention is the software recorded on the recording medium such as FD 632 and CD-ROM 642.

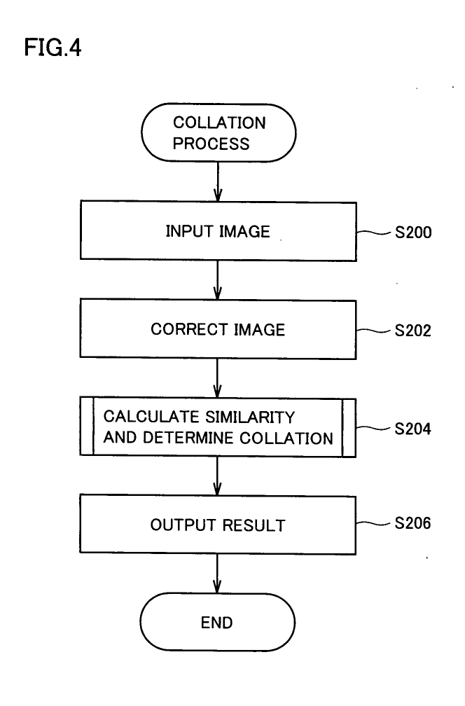

Referring to FIG. 4, a program executed by image collation device 100 has the following control structure in connection with the fingerprint collation.

In step 200 (hereinafter, “step” is alleviated to “S”), control part 1035 transmits a signal indicating the commencement of the image input to input unit 101. After that, control part 1035 remains standby until a signal indicating the termination of the image input is received. Input unit 101 receives the input of image A to be collated and outputs it to image block 1023 of memory unit 102 via bus 105. Image block 1023 stores the image data of image A. Input unit 101 transmits a signal indicating the termination of the image reception to control part 1035 after the reception of image A is completed. Control part 1035 transmits again the signal indicating the start of the image input to input unit 101 when the signal indicating the termination of the image reception is transmitted. After that, control part 1035 again remains standby until the signal indicating the termination of the image input is received. Input unit 101 receives the input of image B as an object of the collation and outputs it to image block 1023 of memory unit 102 via bus 105. Image block 1023 stores therein the image data of image B. Input unit 101 transmits the signal indicating the termination of the image reception after the reception of image B is completed.

In S202, control part 1035 transmits a signal indicating the commencement of the image correction to correction part 1031. After that, control part 1035 remains standby until a signal indicating the termination of the image correction is received. In many cases, the image received by input unit 101 is subjected to influences of a value showing the density difference of each pixel, a density distribution in the whole of the image, a property of input unit 101, a dryness of the fingerprint itself and a pressure by which a finger is pushed. Because of the influences, an image quality of the image received by input unit 101 is not uniform. It is inappropriate to directly use the received image data for collation because the image quality is not uniform. Correction part 1031 corrects the image quality of the inputted image so as to control a variation of conditions when the image is inputted. More specifically, a histogram flattening process, a binarizing process and the like are applied to the whole or the partial regions of the inputted image. Correction part 1031 executes the foregoing processes to both of images A and B. After the processes with respect to images A and B are executed, correction part 1031 transmits the signal indicating the termination of the image correction to control part 1035. The histogram flattening process is realized in the following steps. In a first step, each pixel of the image is classified into different values representing the density (density value). In a second step, the number of the pixels having the same density value is counted. In a third step, the density value of each pixel is changed so that the respective numbers of the pixels having the same density are equalized. As examples of a method of determining at which coordinates the density value of the pixel is changed, a method of extracting an optional pixel and a method of referencing the density value of an adjacent pixel are available. In the present embodiment, at which coordinates the density of the pixel is changed is determined using the method of extracting the optional pixel because it is easy to create an algorism executed by CPU 622. The binarizing process of the image refers to a process in which the density value of the pixel is changed to a maximum value or a minimum value depending on whether or not the density value is equal to or more than a threshold value determined in a method described below. As examples of the method of determining the threshold value, a so-called p-tile method, a mode method, a differential histogram method, a discriminating analysis method, a variable threshold method and the like are available. In the present embodiment, the threshold value is determined by means of the mode method. In the mode method, the threshold value is determined in the following steps. In a first step, a histogram of the number of the pixels per density value is drawn. In a second step, the density value at which a transition of the pixel number per density value shifts from decrease to increase, that is a bottom in the histogram, is detected and used as the threshold value.

In S204, the similarity calculation and the collation determination are implemented to images A and B, which correspond to processes of S210 to S226 described later.

In S206, control part 1035 outputs information representing the collation result stored in reference block 1021 to output unit 104. Output unit 104 outputs the information outputted by control part 1035.

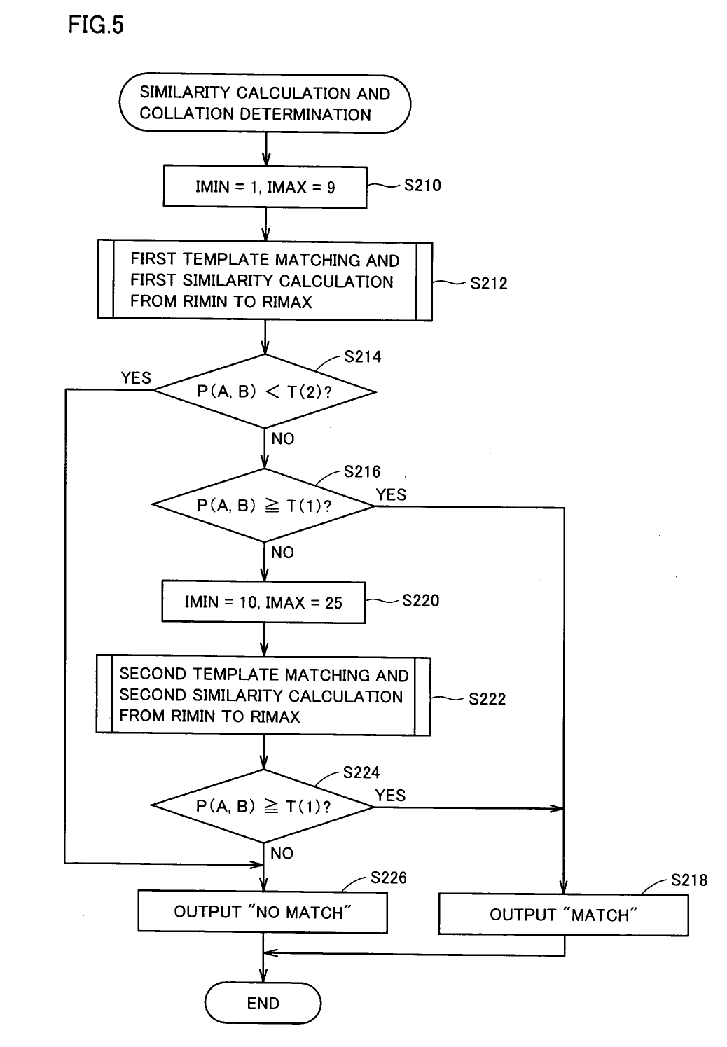

Referring to FIG. 5, the program implemented in image collation device 100 has the following control structure in connection with the similarity calculation and the collation determination.

In S210, control part 1035 transmits a signal indicating the commencement of the collation determination to determination part 1034. When the signal is transmitted, control part 1035 remains standby until a signal indicating the termination of the collation determination is received. Determination part 1034 sets the partial region for which the matching (similarity calculation and collation determination) is implemented to be the central region of FIG. 2, that is the region including partial regions R(1) to R(9). More specifically, determination part 1034 sets a minimum value IMIN as an index of the partial image to “1”, and sets a maximum value IMAX as an index of the partial image to “9”. When the partial region subjected to the matching is set in the present step, it is necessary for the region to include a portion closer to a top joint of the finger than a tip of the finger. In particular, it is vital to set the region so as to include a center of an arc drawn by the fingerprint because, when these portions are set as the partial region, it is made easy to determine whether or not the fingerprints are match. The determination is facilitated because those portions are largely different from one individual to another as taught by the empirical rule. In the present embodiment, a total area of partial regions R(1) to R(9) is approximately 30% of a projected area of the finger in image A. The area is set as above because it is desirable for the total area of partial regions R(1) to R(9) to be in the range of 25 to 40% of the projected area of the finger in image A as taught by the empirical rule.

In S212, search part 1032 and the like implement a first template matching and a first similarity calculation to the partial region subjected to the matching which is set by determination part 1034, which correspond to processes of S230 to S268 described later.

In S214, determination part 1034 determines whether or not a maximum value P(A, B) of the similarity is below a threshold value T(2). When it is determined that it is below threshold value T(2) (YES in S214), the process proceeds to S226. When it is determined otherwise (NO in S214), the process proceeds to S216.

In S216, determination part 1034 determines whether or not maximum value P(A, B) of the similarity is equal to or more than a threshold value T(1) exceeding threshold value T(2). When it is determined that it is equal to or more than threshold value T(1) (YES in S216), the process proceeds to S218. When it is determined otherwise (NO in S216), the process proceeds to S220. In S218, determination part 1034 outputs information indicating “match” to reference block 1021.

In S220, determination part 1034 sets the partial region subjected to the matching to be the peripheral region of FIG. 2, that is partial regions R(10) to R(25). To be more specific, determination part 1034 sets the minimum value IMIN as the index of the partial image to “10”. Further, determination part 1034 sets maximum value IMAX as the index of the partial image to “25”.

In S222, search part 1032 and the like carries out a second template matching and a second similarity calculation to the partial region subjected to the matching which is set by determination part 1034, which correspond to processes of S230 to S268 described later.

In S224, determination part 1034 determines whether or not maximum value P(A, B) of the similarity is equal to or more than threshold value T(1). When it is determined it is equal to or more than threshold value T(1) (YES in S224), the process proceeds to S218. When it is determined otherwise (NO in S224), the process proceeds to S226. In S226, determination part 1034 outputs information indicating “no match” to reference block 1021.

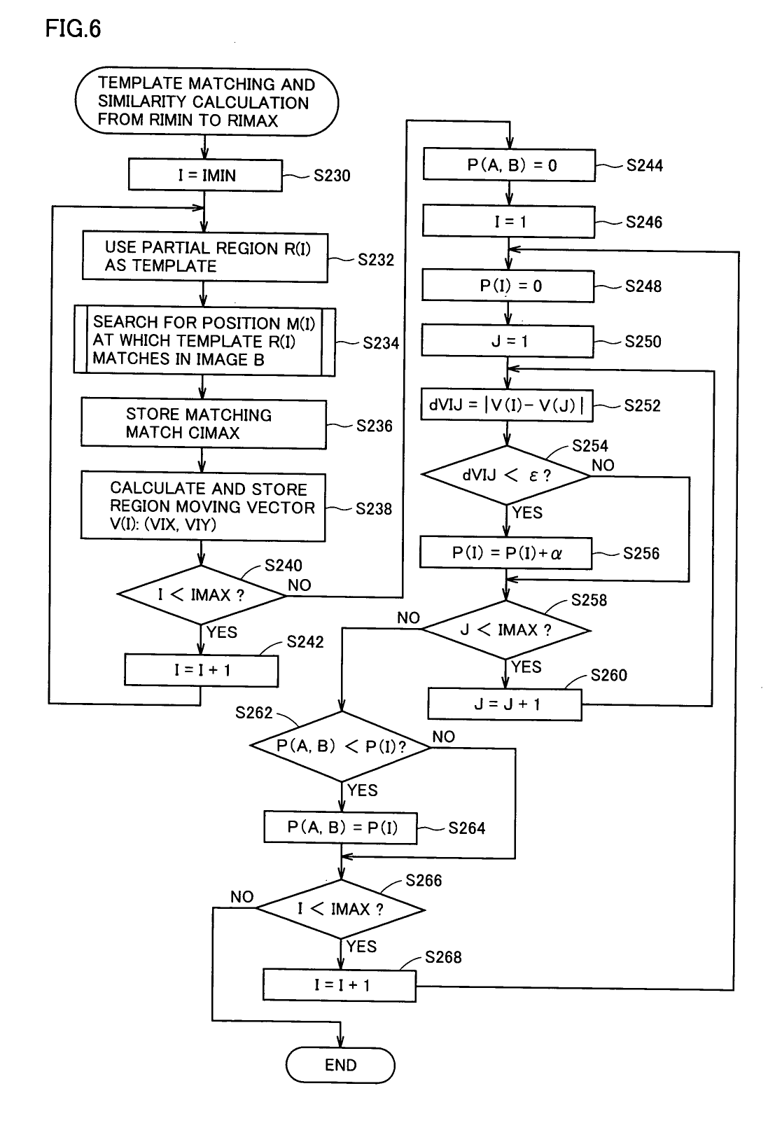

Referring to FIG. 6, the program executed in image collation device 100 has the following control structure in connection with the similarity calculation.

In S230, control part 1035 transmits a signal indicating the start of the template matching to search part 1032. Control part 1035 remains standby until a signal indicating the termination of the template matching is received. Control part 1032 sets a value of a counter variable I to be index minimum value IMIN.

In S232, search part 1032 sets an image of a partial region R(I) from image A as a template used in the template matching. To describe more specifically, search part 1032 copies the image of partial region R(I) of image A in reference block 1021. A shape of partial region R(I) is not particularly limited, though partial region R(1) has a rectangular shape in the present embodiment because the shape makes the calculation easier. Further, partial region R(I) according to the present embodiment is such a region that a length of a line crossing partial region R(I) and orthogonal to a ridge (line drawing the fingerprint) is equal to or more than twice and equal to or below three times as long as a sum of a width of the ridge and a width of a groove (groove between the ridges) because it is evident that the fingerprint collation can be precisely carried out when the shape of the partial region is set as described as taught by the empirical rule.

In S234, search part 1032 searches a region of a maximum match in image B, that is a region in which the image data is the most match in connection with the template set in S232. Thereby, a maximum match CIMAX of the template set in S232, that is partial region R(I) is calculated. The foregoing process corresponds to processes of S270 to S276 which will be described later.

In S236, search part 1032 makes memory unit 102 store maximum match CIMAX of partial region R(I) calculated in S234. When a value of “I” is in the range of “1” to “9”, maximum match CIMAX is stored in first region 1024. When the value of “I” is anything beyond the foregoing range, maximum match CIMAX is stored in second region 1025.

In S238, search part 1032 calculates a moving vector V(I) by means of Equation (1). When moving vector V(I) is calculated, search part 1032 makes memory unit 102 store moving vector V(I). When the value of “I” is in the range of “1” to “9”, moving vector V(I) is stored in first region 1024. When the value of “I” is anything beyond the foregoing range, moving vector V(I) is stored in second region 1025. As is clear from Equation (1), the “moving vector” refers to a direction vector from positional information of partial region (I) to positional information of the closest-matching region in image B (upper-left top of partial region M(I) which will be described later) when an upper-left top the of image A and an upper-left top of image B are overlapped with each other. In general, a magnitude of moving vector V(I) is not “0” because, when images A and B are compared to each other, the positions of images A and B are different as if the finger moved. The positions of the images are different because the finger is not uniformly placed in input unit 101.
V(I)=(VIX,VIY)=(MIX−RIX,MIY−RIY) (1)

In the present embodiment, variables RIX and RIY are respectively an X coordinate and a Y coordinate of the upper-left top of partial region R(I) in image A. Variables MIX and MIY are respectively an X coordinate and a Y coordinate of the upper-left top of partial region M(I).

In S204, search part 1032 determines whether or not the value of counter variable I is below maximum value IMAX (=9) as the index of the targeted partial region. When it is determined that it is below maximum value IMAX (=9) (YES in S240), the process proceeds to S242. When it is determined otherwise (NO in S240), the process proceeds to S244. In S242, search part 1032 increases the value of variable I by “1”.

In S244, search part 1032 transmits the signal indicating the termination of the template matching to control part 1035. Control part 1035 transmits a signal indicating the start of the similarity calculation to calculation part 1033. When the signal is transmitted, control part 1035 remains standby until a signal indicating the termination of the similarity calculation is received. When the signal transmitted, calculation part 1033 initializes maximum value P(A, B) of the similarity to “0”. In the present embodiment, maximum value P(A, B) of the similarity is a variable for storing the maximum value of the similarity between images A and B.

In S246, calculation part 1033 initializes the value of counter variable I to “1”.

In S248, calculation part 1033 initializes a similarity P(I) relating to moving vector V(I) as a reference to “0”. In S250, calculation part 1033 initializes a value of a counter variable J to “0”. In S252, calculation part 1033 calculates a vector differential dVIJ between the reference moving vector V(I) and a moving vector V(J) to be compared thereto by means of Equation (2).

$$\begin{matrix} dVIJ - \vert V ( I ) - V ( J ) \vert = SQRT ( F ) \\ = SQRT ( {( VIX - VJX )}^{2} + {( VIY - VJY )}^{2} )\end{matrix} \qquad ( 2 )$$

A variable VIX represents an element in an X direction of moving vector V(I). A variable VIY represents an element in a Y direction of moving vector V(I). A variable VJX represents an element in an X direction of moving vector V(J). A variable VJY represents an element in a Y direction of moving vector V(J). A function SQRT (F) represents a square root of a value F.

In S254, calculation part 1033 determines whether or not moving vector V(I) and moving vector V(J) are substantially identical. More specifically, calculation part 1033 determines whether or not vector differential dVIJ is below a constant E. When it is determined that they are substantially identical (YES in S254), the process proceeds to S256. When it is determined otherwise (NO in S254), the process proceeds to S258. In S256, calculation part 1033 increases a value of similarity P(I) by means of Equation (3).
P(I)=P(I)+α (3)

A variable α is a value for increasing similarity P(I). In the present embodiment, a value of variable α can be optionally set in the designing process so as to correspond to a magnitude of vector differential dVIJ. For example, when α=1, the value of similarity P(I) represents the number of the partial region having a moving vector identical to the reference moving vector V(I). When α=CIMAX, similarity P(I) stands for a sum total of maximum match CIMAX.

In S258, calculation part 1033 determines whether or not counter variable J is below maximum value IMAX (=9) as the index of the partial region. When it is determined that it is below maximum value IMAX (=9) (YES in S258), the process proceeds to S260. When it is determined otherwise (NO in S258), the process proceeds to S262. In S260, calculation part 1033 increases the value of counter variable J by “1”.

In S262, calculation part 1033 determines whether or not similarity P(I) in the case of moving vector V(I) being the reference is larger than maximum value P(A, B) of the similarity. When it is determined that similarity P(I) is larger than maximum value P(A, B) of the similarity (YES in S262), the process proceeds to S264. When it is determined otherwise (NO in S262), the process proceeds to S266. In S264, calculation part 1033 assigns the value of similarity P(I) when moving vector V(I) serves as the reference to maximum value P(A, B) of the similarity.

In S266, calculation part 1033 determines whether or not the value of counter variable I in the case of moving vector V(I) being the reference is smaller than maximum value IMAX (=9) as the index of the partial region. When it is determined that the value of counter variable I is smaller than the index maximum value IMAX (YES in S266), the process proceeds to S268. When it is determined otherwise (NO in S266), the process is terminated. In S268, calculation part 1033 increases the value of counter variable I by “1”.

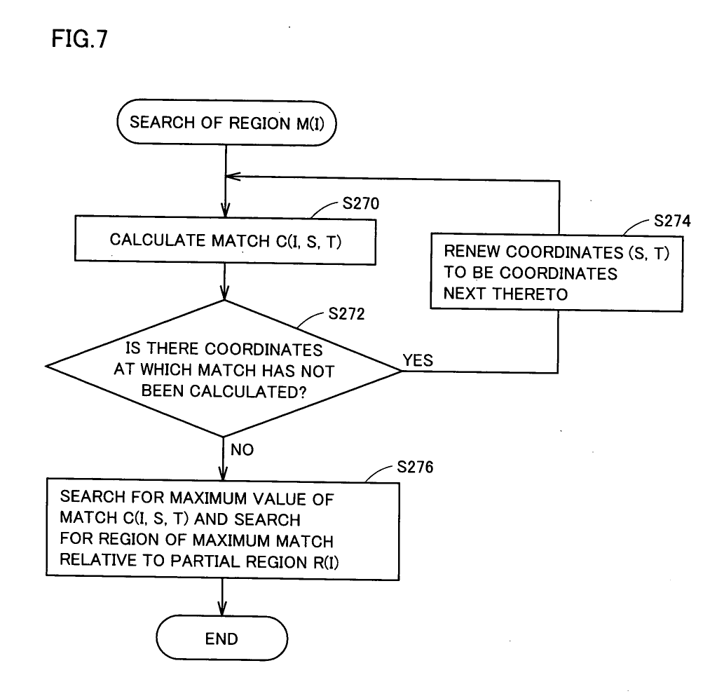

Referring to FIG. 7, the program executed in image collation device 100 has the following control structure in connection with the search of region M(I), that is the match calculation.

In S270, search part 1032 calculates a match level C(I, S, T) by means of Equation (4) (the equation used for the calculation of the match is not necessarily limited to Equation (4), however, the match is calculated by means of Equation (4) in the present embodiment.). When match level C(I, S, T) is calculated, search part 1032 makes a value of match level C(I, S, T) correspond to counter variable I and coordinates (S, T) of image B and stores the value in reference block 1021. R(I, X, Y) represents the density value of the pixel at coordinates (X, Y) on partial region R(I), while B(S, T) represents the density value at coordinates (S, T) on image B. When coordinates (S, T) exceed a maximum value of the coordinates of image B, the value of B(S, T) is “0”. W represents a width of partial region R(I). H represents a height of partial region R(I). V(O) represents a maximum density value obtainable by each pixel in images A and B. C(I, S, T) is a value representing the match level between a region based on coordinates (S, T) and having a width of W and a height of H and partial region R(I). In the present embodiment, the coordinates of partial region R(I) and image B are respectively based on the upper-left top portion thereof.

$$C ( I , S , T ) - {\sum }_{Y = 1}^{H} {\sum }_{X = 1}^{W} ( V ( 0 ) - \vert R ( I , X , Y ) - B ( S + X , T + Y ) \vert ) \qquad ( 4 )$$

In S272, search part 1032 determines whether or not there are coordinates of image B whose match level C(I, S, T) has not been calculated. When it is determined there are coordinates whose match level C(I, S, T) has not been calculated (YES in S272), the process proceeds to S274. When it is determined otherwise (NO in S272), the process proceeds to S276.

In S274, search part 1032 renews the coordinates of image B(S, T) to be coordinates next to the coordinates whose match level C(I, S, T) has been calculated in S272. In the present embodiment, search part 1032, in the absence of the next coordinates, renews the coordinates of image B(S, T) to be coordinates directly below the coordinates whose match level C(I, S, T) has been calculated in S272. In the present embodiment, initial values of coordinates (S, T) are (0, 0), that are the coordinates representing the upper left of image B.

In S276, search part 1032 searches the maximum value from match level C(I, S, T) stored in reference block 1021. When maximum value CIMAX of match level C(I, S, T) has been found, search part 1032 identifies a region based on the coordinates of coordinates (S, T) of image B at which maximum value CIMAX has been calculated having the width of W and the height of H as a region having the maximum match level relative to partial region R(I). The region regarded as having the maximum match level relative to partial region R(I) is called partial region M(I). In the present embodiment, the upper-left coordinates of partial region M(I) are (MIX, MIY).

An operation of image collation device 100 based on the foregoing structures and flowcharts is described.

(When No Match can be Determined from Collation of Center Portion of Finger Only)

Control part 1035 transmits the signal indicating the start of the image input to input unit 101. Input unit 101 receives the input of image A to be collated and outputs it to image block 1023 of memory unit 102 via bus 105. Image block 1023 stores the image data of image A. Input unit 101 receives the input of image B to be collated and outputs it to image block 1023 of memory unit 102 via bus 105. Image block 1023 stores the image data of image B (S200).

When the image data of image B is stored, control part 1035 transmits the signal indicating the start of the image correction to correction part 1031. Correction part 1031 corrects the image quality of the inputted image so as to control the variation of the conditions when the image is inputted (S202).

When the image quality is corrected, control part 1035 transmits the signal indicating the start of the collation determination to determination part 1034. Determination part 1034 sets the partial region subjected to the matching to be partial regions R(1) to R(9) (S210).

When the partial regions are set, control part 1035 transmits the signal indicating the start of the template matching to search part 1032. Search part 1032 sets counter variable I to be index minimum value IMIN (S230). When variable I is set, search part 1032 sets the image of partial region R(I) from image A as the template used for the template matching (S232).

When the template is set, search part 1032 searches a region having a highest match level in image B, that is a region in which the image data is the closest-matching in connection with the set template (S234). Search part 1032 calculates match level C(I, S, T). When match level C(I, S, T) is calculated, search part 1032 makes the value of match level C(I, S, T) correspond to counter variable I and coordinates (S, T) of image B and stores the value in reference block 1021 (S270). When the value is stored, search part 1032 determines whether or not there are coordinates whose match level C(I, S, T) has not been calculated in the coordinates of image B (S272). While there are coordinates whose match level C(I, S, T) has not been calculated (YES in S272), search part 1032 renews the coordinates of image B(S, T) to be the coordinates next to the coordinates whose match level C(I, S, T) has been calculated in S272 (S274), and the processes of S270 to S272 are repeated. After there are no longer coordinates whose match level C(I, S, T) has not been calculated (NO in S272), search part 1032 searches the maximum value from match level C(I, S, T) stored in reference block 1021 (S276). When maximum match CIMAX is calculated, search part 1032 makes memory unit 102 store maximum match CIMAX of partial region R(I) calculated in S234 (S236).

When maximum match CIMAX is stored, search part 1032 calculates moving vector V(I). When moving vector V(I) is calculated, search part 1032 makes memory unit 102 store moving vector V(I) (S238).

When moving vector V(I) is stored, search part 1032 determines whether or not the value of counter variable I is below maximum value IMAX (=9) as the index of the targeted partial region (S240). While the value of counter variable I is equal to or below the index maximum value IMAX (=9) as the index of the targeted partial region (YES in S240), the value of counter variable I is increased by “1” (S242), and the processes of S232 to S242 are repeated. In such a manner, the template matching is carried out to all of partial regions R(I). The template matching is carried out to all of partial regions R(I), and further, maximum match CIMAX and moving vector V(I) for each partial region R(I) are calculated. Search part 1032 stores maximum match CIMAX and moving vector V(I) of the respective partial regions R(I), which are sequentially calculated, in a predetermined area of memory unit 102. Thus, the similarity in any portion of image B relative to the partial region of image A can be determined.

When it is finally determined that the value of counter variable I is equal to or more than maximum value IMAX (=9) as the index of the targeted partial region (NO in S240), calculation part 1033 initializes maximum value P(A, B) of the similarity to “0” (S244). When maximum value P(A, B) is initialized, calculation part 1033 initializes the value of counter variable I to “1” (S246). When the value of counter variable I is initialized, calculation part 1033 initializes similarity P(I) relating to the reference moving vector V(I) to “0” (S248). When the value of similarity P(I) is initialized, calculation part 1033 initializes the value of counter variable J to “1” (S250). When the value of counter variable J is initialized, calculation part 1033 calculates vector differential dVIJ between the reference moving vector V(I) and moving vector V(J) to be compared thereto (S252).

When vector differential dVIJ is calculated, calculation part 1033 determines whether or not moving vector V(I) and moving vector V(J) are substantially identical (S254). When it is determined that they are substantially identical (YES in S254), calculation part 1033 increases the value of similarity P(I) (S256). When the value of similarity P(I) is increased, calculation part 1033 determines whether or not counter variable J is below maximum value IMAX (=9) as the index of the partial region (S258). While counter variable J is below maximum value IMAX (=9) (YES in S258), calculation part 1033 increases the value of counter variable J by “1” (S260). In executing the processes of S250 to S260, similarity P(I) is calculated from the information of the partial region determined to have the same moving vector as the reference moving vector V(I). Calculation part 1033 identifies a correlativity between the layout of a plurality of partial regions and the layout of any portion of image B having the highest match level.

When counter variable J finally is equal to or more than maximum value IMAX (NO in S258), calculation part 1033 determines whether or not similarity P(I) in the case of moving vector V(I) being the reference is larger than maximum value P(A, B) of the similarity (S262). When it is determined that similarity P(I) is larger than maximum value P(A, B) of the similarity (YES in S262), calculation part 1033 assigns the value of similarity P(I) when moving vector V(I) is used as the reference to maximum value P(A, B) of the similarity (S264). In S262 and S264, moving vector V(I) in which the value of similarity P(I) achieves the highest level is determined to be the most appropriate as the reference moving vector. When the value of similarity P(I) is assigned, calculation part 1033 determines whether or not the value of counter variable I in the case of the reference moving vector V(I) being the reference is smaller than maximum value IMAX (=9) as the index of the partial region (S266). When it is determined that the value of counter variable I is smaller than maximum value IMAX (YES in S266), calculation part 1033 increases the value of counter variable I by “1” (S268). As a result of the processes of S244 to S268, calculation part 1033 calculates the similarity between images A and B as the value of variable P(A, B). Calculation part 1033 stores the calculated value of variable P(A, B) at a predetermined address in memory unit 102. When the value is stored, calculation part 1033 transmits the signal indicating the termination of the similarity calculation to control part 1035.

After the value of counter variable I is equal to or more than maximum value IMAX (NO in S266), determination part 1034 determines whether or not maximum value P(A, B) of the similarity (and by extension, possibility that the central region of image A is match with any portion of image B) is below threshold value T(2) (S214). In the present example, it is determined that it is below threshold value T(2) (YES in S214). Then, determination part 1034 outputs the information indicating “no match” to reference block 1021 (S226). When the information is outputted, control part 1035 outputs the information representing the collation result stored in reference block 1021 to output unit 104. Output unit 104 outputs the information outputted by control part 1035 (S206).

(Case where Match can be Determined by Only Collation of Center Portion of Fingerprint)

After the processes of S200 to S268, determination part 1034 determines whether or not maximum value P(A, B) of the similarity is below threshold value T(2) (S214). In the present case, it is determined that it is equal to or more than threshold value T(2) (NO in S214), determination part 1034 determines whether or not maximum value P(A, B) of the similarity (and by extension, possibility that the central region of image A matches with any portion of image B) is equal to or more than threshold value T(1) exceeding threshold value T(2) (S216). In the present case, it is determined that it is equal to or more than threshold value T(1) (YES in S216), determination part 1034 outputs the information indicating “match” to reference block 1021 (S218).

(Case where Determination Remains Undetermined by Only Collation Based on Center Portion of Fingerprint)

After the processes of S200 to S268, determination part 1034 determines whether or not maximum value P(A, B) of the similarity is below threshold value T(2) (S214). In the present case, determination part 1034 determines that maximum value P(A, B) of the similarity (and by extension, possibility that the central region of image A matches with any portion of image B) is equal to or more than threshold value T(2) (NO in S214), based on which determination part 1034 itself determines whether or not image A matches with image B. In order to do so, determination part 1034 first determines whether or not maximum value P(A, B) of the similarity is equal to or more than threshold value T(1) exceeding threshold value T(2) (S216). In the present example, it is determined that it is below threshold value T(1) (more specifically, the result of the fingerprint collation falls under “undetermined” because maximum value P(A, B) of the similarity is more than threshold value T(2) and below threshold value T(1).) (NO in S216). Therefore, determination part 1034 sets the partial region subjected to the matching to be partial regions R(10) to R(25) (S220). When the partial regions are set, determination part 1034, after the processes of S230 to S268, determines whether or not maximum value P(A, B) of the similarity is equal to or more than threshold value T(1) (S224). When it is determined that it is equal to or more than threshold value T(1) (YES in S224), determination part 1034 outputs the information indicating “match” to reference block 1021 (S218).

As so far described, image collation device 100 according to the embodiment carries out, first, the collation based on a portion of the image. Then, the collation is terminated when the images matches or not can be determined in the foregoing collation. The number of the searched partial regions in the collation decreases by 74% compared to the conventional technology (100−9 regions/25 regions×100=74). When it cannot be determined if the images match with each other, the collation is carried out to the whole of the image. Thereby, when the collation can be successfully done with only a portion of the image, the rest of the image is not subjected to the collation. Further, the portion of the image used for the collation is the portion effectively exhibiting the characteristics of the image (in the case of the image representing the fingerprint, the portion closer to the top joint of the finger than the tip of the finger, more particularly to the portion including the center of the arc drawn by the fingerprint). Therefore, the collation can be still carried out with a high precision based on only a portion of the image. As a result, the image collation device capable of reducing the power consumption and obtaining the high collating precision with the reduced amount of searches without being largely affected by the presence/absence or number of the characteristics, visibility of the image, environmental changes when the image in input, noises and the like.

When a large number of images are collated, the image collation device according to the present embodiment may omit S216 because most of the images result in “no match” when many images are collated. Therefore, the process of S220 is implemented anyway in most cases irrespective of the implementation or omission of the process of S216.

The processes of S210 to S226 may be executed after image A is corrected to be tilted. In the foregoing case, a relationship between the tilt of image A and maximum value P(A, B) of the similarity is quantified, and the whether or not images A match with images B is determined depending on whether or not maximum value P(A, B) of the similarity is equal to or more than the threshold value and the like when maximum value P(A, B) of the similarity is at the highest level.

Images A and B may not necessarily represent the fingerprint as long as they represent the pattern inherent in the human body (fingerprint, retina, iris, palmer pattern, physiognomy or the like). Further, images A and B may be the image representing the pattern such as imprint. In the case in which images A and B are the pattern formed by the configuration of the vasa sanguinea retinae or vasa sanguinea chorioidea, there is such an effect that the time difference between the time point when one of the images was photographed and the time point when the other image was photographed can be estimated to a certain extent because the configuration gradually changes over time. Moreover, in the case in which images A and B represent the configuration of the vasa sanguinea retinae or vasa sanguinea chorioidea in the portion including the optic nerve papilla, the foregoing time difference can be estimated while the possibility of false recognition due to the lapse of time is being controlled because the possibility that the vasa sanguinea retinae or vasa sanguinea chorioidea in the portion including the optic nerve papilla largely changes is not very high. The foregoing possibility is not so high because there are other vasa sanguinea retinae and vasa sanguinea chorioidea in the vicinity of the vasa sanguinea retinae or vasa sanguinea chorioidea in the portion including the optic nerve papilla, which causes themselves to restrict one another for any change. There are other vasa sanguinea retinae and vasa sanguinea chorioidea because the vasa sanguinea retinae and vasa sanguinea chorioidea both peripherally spread from the vicinity of the optic nerve papilla.

In the present embodiment, the determinations in S214, S216 and S224 may be respectively executed by another circuit making it unnecessary for the circuit such as determination part 1034 to execute a plurality of determinations.

Although the present invention has been described and illustrated in detail, it is clearly understood that the same is by way of illustration and example only and is not to be taken by way of limitation, the spirit and scope of the present invention being limited only by the terms of the appended claims.

1. An image collation device comprising:
a reception device for receiving data representing a first image and data representing a second image;
a first determination circuit for determining whether or not a possibility that a first portion which is a portion of said first image matches with any portion of said second image is below a predetermined first value; and
a second determination circuit for determining whether or not said first image matches with said second image when said first determination circuit determines the possibility that said first portion matches with the any portion of said second image is equal to or more than said first value.

2. The image collation device according to claim 1, further comprising:
a third determination circuit for determining whether or not the possibility that said first portion matches with the any portion of said second image is equal to or more than a second value exceeding said first value, wherein
said second determination circuit includes a circuit for determining whether or not said first image matches with said second image when the possibility that said first portion matches with the any portion of said second image is equal to or more than said first value and below said second value.

3. The image collation device according to claim 1, wherein
said first determination circuit includes:
a specified circuit for similarity for specifying a similarity of the any portion of said second image relative to a partial region which is a portion of said first portion;
a specified circuit for correlation for specifying a correlativity between a layout of a plurality of partial regions and a layout of the any portion of the second image having a highest similarity; and
a circuit for determining whether or not said correlativity is below said first value.

4. The image collation device according to claim 1, wherein
said second determination circuit includes a specified circuit for similarity for specifying a similarity of the any portion of said second image relative to the partial region which is a portion of said first image, a specified circuit for correlation for specifying the correlativity between a layout of said partial regions and a layout of said portion having the highest similarity, and a circuit for determining whether or not said correlativity is below a predetermined value.

5. The image collation device according to claim 4, wherein
said first image and said second image include an image representing a fingerprint, and said partial region includes a region in which a length of a line crossing said partial region and orthogonal to a ridge of said fingerprint is equal to or more than twice and equal to or less than three times as long as a sum of a width of said ridge and a width of a groove.

6. The image collation device according to claim 1, wherein
said first image and said second image include an image representing a pattern inherent in a human body.

7. The image collation device according to claim 6, wherein
said pattern inherent in the human body includes a pattern formed by a configuration of a vasa sanguinea retinae or a vasa sanguinea chorioidea.

8. The image collation device according to claim 1, wherein
said first image and said second image include an image representing a configuration of a vasa sanguinea retinae or a vasa sanguinea chorioidea, and said first portion is a portion including an optic nerve papilla.

9. The image collation device according to claim 1, wherein
said first image and said second image include an image representing a fingerprint, and said first portion includes a portion closer to a top joint of a finger than a tip of said finger.

10. The image collation device according to claim 9, wherein
said portion closer to the top joint of the finger than the tip of the finger includes a center of an arc drawn by said fingerprint.

11. The image collation device according to claim 1, wherein
said first image and said second image include an image representing a fingerprint of a finger, and an area of said first portion is an area corresponding to 25 to 40% of a projected area of said finger.

12. The image collation device according to claim 1, wherein
said first image and said second image include an image representing an imprint.

13. An image collation method comprising:
a reception step of receiving data representing a first image and data representing a second image;
a first determination step of determining whether or not a possibility that a first portion which is a portion of said first image matches with any portion of said second image is below a predetermined first value; and
a second determination step of determining whether or not said first image matches with the second image when it is determined the possibility that said first portion matches with the any portion of said second image is equal to or more than said first value in said first determination step.

14. An image collation program for making a computer execute:
a reception step of receiving data representing a first image and data representing a second image;
a first determination step of determining whether or not a possibility that a first portion which is a portion of said first image matches with any portion of said second image is below a predetermined first value; and
a second determination step of determining whether or not said first image matches with the second image when it is determined the possibility that said first portion matches with the any portion of said second image is equal to or more than said first value in said first determination step.

15. A computer-readable recording medium with an image collation program for making a computer execute the following steps recorded thereon:
a reception step of receiving data representing a first image and data representing a second image;
a first determination step of determining whether or not a possibility that a first portion which is a portion of said first image matches with any portion of said second image is below a predetermined first value; and
a second determination step of determining whether or not said first image matches with the second image when it is determined the possibility that said first portion matches with the any portion of said second image is equal to or more than said first value in said first determination step.
